(19) United States
(12) Patent Application Publication
(10) Pub. No.: US 2025/0035816 A1
(43) Pub. Date: Jan. 30, 2025

(54) METHOD FOR DYNAMICALLY ASSESSING SLOPE SAFETY

(71) Applicant: INSTITUTE OF MECHANICS, CHINESE ACADEMY OF SCIENCES

(72) Inventors: Chun FENG, Beijing (CN); Xinguang ZHU, Beijing (CN); Pengda CHENG, Beijing (CN); Yu ZHOU, Beijing (CN); Lixiang WANG, Beijing (CN); Yongbo FAN, Beijing (CN); Li ZHANG, Beijing (CN)

(73) Assignee: INSTITUTE OF MECHANICS, CHINESE ACADEMY OF SCIENCES, Beijing (CN)

(21) Appl. No.: 18/911,236

(22) Filed: Oct. 9, 2024

Related U.S. Application Data
(63) Continuation-in-part of application No. 18/089,590, filed on Dec. 28, 2022, now abandoned.

(30) Foreign Application Priority Data
Dec. 30, 2021 (CN) 202111651736.1

(51) Int. Cl. G01V 20/00; G06F 30/17; G06F 30/27; G06F 119/02

(52) U.S. Cl. CPC G01V 20/00; G06F 30/17; G06F 30/27; G06F 2119/02

(57) ABSTRACT

The present invention discloses a method for dynamically assessing slope safety, and the method comprises the following steps: S1, carrying out geologic model generalization to the slope according to slope type, surface elevation, slope structure, stratum characteristics and a deformation failure mode to obtain a slope geologic model, creating a slope geometric model according to the said slope geologic model, carrying out the subdivision of computational grid, and selecting a reasonable numerical simulation method, mechanical constitutive and initial boundary value conditions to form a computational model; and S2, adjusting stratum parameters, structural plane parameters and activating factor strength based on the said computational model, carrying out a large amount of numerical simulation, summarizing results of the said numerical simulation, normalizing input quantities and output quantities to establish machine learning samples.

### CROSS REFERENCE TO RELATED APPLICATIONS

This application is a continuation in part of U.S. patent application Ser. No. 18/089,590 filed on filed on Dec. 28 2022, the contents of which are hereby incorporated by reference in their entirety.

### FIELD

The present invention relates to technical fields of slope safety, and particularly to a method for dynamically assessing slope safety.

### BACKGROUND

The gestation, development, evolution, and disaster process of the landslide disaster are accompanied by changes in large amount of macroscopically measurable physical information, such as surface displacement, deep displacement, surface dip, pore water pressure, water content of geological bodies, etc. By capturing the above physical information in real time, it is possible to establish a mapping relation between the physical information and the evolution stage of the landslide disaster, which further provides the necessary basic data for the scientific early warning of the landslide. With the development of sensing technology, information technology and Internet of Things technology, it has been relatively mature to acquire the information such as deformation, stress, water level, pore pressure and the like on the surface and inside of the slope in real time with the help of various types of automatic monitoring equipment. However, as the monitoring data accumulates, how to carry out accurate assessment on the slope safety based on the monitoring data and slope characteristics is a common problem that the current academic and industrial circles face.

At present, the common practice is to carry out fitting and deduction based on limited data, such as Saito model, gray prediction theory, three-stage displacement model, etc. These methods are all mathematical methods, which carry out data analysis to reasonably extrapolate the evolution law of future monitoring point displacement (or other physical quantities). However, such methods do not take into consideration the influence of geological structure, slope characteristics, activating factors and the like on the law of development and evolution of the disaster. Therefore, the analysis method purely based on the monitoring data has relatively large limitations, and is generally only applicable to the internal cause-dominated critical landslide forecast, that is, the landslide has already started at this time, and would lead to the disaster due to the internal cause (such as gravity) without any external factors.

In recent years, with the development of artificial intelligence, the method of early warning and analysis of landslide disaster using the AI technology and the big data analysis technology has gradually formed. The core of AI is to create an embedded analysis model and model parameters using a large number of sampling cases, and then provide predictive analysis. However, for the landslide disaster, the effective sampling cases are extremely lacking. It is because the so-called effective sampling case needs to track the whole life cycle of the landslide disaster, that is, the monitoring information on occurrence, development, evolution and stop process of the landslide is complete. With the development of computer technology, the numerical simulation technology based on mechanical theory has played an important role in the optimization design of engineering slope, the stability analysis of natural slope, the assessment of the range of slope disaster, etc. At present, the underlying mechanical algorithms used in the numerical simulation have been relatively mature, but due to the heterogeneity of geological bodies and the limitation in survey costs, it is impossible to accurately acquire the physical and mechanical parameters at each site of the geological body, which affects the analysis and prediction accuracy of the numerical simulation. In addition, the numerical simulation often takes a long time, for example, hours or days are often needed in one simulation, which greatly limits the application of numerical simulation to the rapid predictive analysis of slope safety.

### SUMMARY

The object of the present invention is to provide a method for dynamically assessing slope safety, so as to solve the technical problem that the underlying mechanical algorithms used in the numerical simulation in the conventional technology have been relatively mature, but due to the heterogeneity of geological bodies and the limitation in survey costs, it is impossible to accurately acquire the physical and mechanical parameters at each site of the geological body, which affects the analysis and prediction accuracy of the numerical simulation; and in addition, the numerical simulation often takes a long time, for example, hours or days are often needed in one simulation, which greatly limits the application of numerical simulation to the rapid predictive analysis of slope safety.

In order to solve the above technical problems, the present invention specifically provides the following technical solutions:

A method for dynamically assessing slope safety, comprising:
step S1, carrying out geologic model generalization to the slope according to slope type, surface elevation, stratum characteristics, slope structure and a deformation failure mode to obtain a slope geologic model, creating a slope geometric model according to the said slope geologic model, carrying out the subdivision of computational grid, and selecting a reasonable numerical simulation method, mechanical constitutive and initial boundary value condition to form a computational model;
step S2, adjusting stratum parameters, structural plane parameters and activating factor strength based on the said computational model, carrying out a large amount of numerical simulation, summarizing results of the said numerical simulation, normalizing input quantities and output quantities to create machine learning samples, and randomly dividing the said learning samples into a sample A for machine learning and a sample B for machine prediction;
step S3, carrying out neural network selection and initialization settings, including determining the number of neurons at input and output terminals, determining the number of hidden layers and the number of neurons in each layer, selecting an activating function and an initial value of the weight coefficient, inputting the said sample A to the neural network for learning, adjusting and optimizing transfer coefficients between neurons of the respective layers in the neural network to form a first surrogate model for slope safety prediction, and then inputting the said sample B to the said first surrogate model for prediction verification, and further adjusting the weight coefficient in the first surrogate model to form a second surrogate model for slope safety prediction with high reliability;
step S4, based on the geomechanical parameters in the initial state, inputting the activating factor data monitored on site of the slope into the second surrogate model, calculating the deformation failure situation of the slope, comparing the surface and internal mechanical response monitoring data of the slope with the calculation data of the corresponding positions in the second surrogate model to dynamically adjust the geomechanical parameters of the respective positions in the second surrogate model; and inputting the adjusted geomechanical parameters into the second surrogate model again to calculate the deformation failure situation of the slope and the disaster process; and
step S5, repeating step S4 to realize the dynamic assessment of future slope safety.

As a preferred solution of the present invention, the said slope type includes rocky slope, soil slope, and bedrock and overburden slope, the said slope structure includes a bedding structure, an anti-dip structure, a blocky structure, a loose structure, and a soil-rock mixture structure, the said deformation failure mode includes slipping landslide, toppling failure, and collapse failure.

As a preferred solution of the present invention, the said computational grid includes two-dimensional triangle, quadrilateral, polygon and disk grids, and three-dimensional tetrahedron, triangular prism, pyramid, hexahedron, polyhedron, and sphere grids.

As a preferred solution of the present invention, the said numerical simulation method includes a finite element method, a finite volume method, a finite difference method, a block discrete element method, a particle discrete element method, and a meshless method.

As a preferred solution of the present invention, the said mechanical constitutive includes Drucker-Prager constitutive, Mohr-Coulomb constitutive, Hoek-Brown constitutive, ubiquitous joint constitutive, and fracture energy constitutive.

As a preferred solution of the present invention, the said geomechanical parameters include density, elastic modulus, Poisson's ratio, cohesion, internal friction angle, tensile strength, dilatancy angle, tensile fracture energy, and shear fracture energy.

As a preferred solution of the present invention, the said neural network comprises a forward neural network and a feedback neural network, the said forward neural network comprises a single-layer perceptron, multi-layer perceptron, BP neural network, and the said feedback neural network includes Hopfield, Hamming, BAM network.

As a preferred solution of the present invention, the said activating factor includes rainfall, reservoir water or groundwater fluctuations, earthquakes, manual excavation, and engineering blasting disturbances.

As a preferred solution of the present invention, the said dynamic assessment of slope safety includes stability assessment and disaster risk assessment.

As a preferred solution of the present invention, the said inversion method of geomechanical parameters in slope current state includes a gradient descent method, a conjugate gradient method, and a Newton method.

Compared with the conventional technologies, the present invention has the following beneficial effects.

The present invention combines on-site monitoring data, numerical simulation analysis and neural network prediction, creates geometric model and computational grid according to the slope type, provides samples for machine learning through a large number of numerical simulations, carries out deep learning with the help of the neural network to form the surrogate model for real-time prediction of the slope safety, carries out dynamic inversion on the geomechanical parameters in the surrogate model using the monitoring data to form accurate geomechanical input parameters of the current state, and inputs the adjusted geomechanical parameters into the surrogate model to dynamically assess the future slope safety. Compared with the conventional slope safety prediction model based only on the monitoring data, the present invention has higher prediction accuracy and is able to analyze and predict the range of the slope disaster. Compared with the conventional numerical simulation analysis, the present invention is able to dynamically adjust the geomechanical input parameters by using the monitoring data, making the prediction accuracy further higher, and can further achieve the real-time prediction due to the use of the surrogate model created by the neural network.

### BRIEF DESCRIPTION OF THE DRAWINGS

In order to illustrate the embodiments of the present invention or the technical solutions in the conventional technologies more clearly, the accompanying drawings required to be used in the description of the embodiments or the conventional technologies will be briefly described. Obviously, the drawings described below are merely exemplary, and can be further used to derive other implementation drawings by those skilled in the art without any creative efforts.

FIG. 1 is a flowchart of the method for dynamically assessing slope safety provided by an embodiment of the present invention;

FIG. 2 is a flowchart of the slope safety assessment provided by the embodiment of the present invention;

FIG. 3 is a flowchart of the numerical simulation for slope safety provided by the embodiment of the present invention;

FIG. 4 is a flowchart of learning and prediction based on the neural network provided by the embodiment of the present invention;

FIG. 5 is a flowchart of the inversion of geomechanical parameters in the current state of the slope provided by the embodiment of the present invention;

FIG. 6 is a flow chart of general steps for computational model construction provided by the embodiment of the present invention;

FIG. 7 is a diagram showing a generalized geologic model of a bedding rocky slope provided by the embodiment of the present invention;

FIG. 8 is a flowchart of general steps for solving by coupling finite elements and discrete elements according to the embodiment of the present invention;

FIG. 9 is diagram showing a generalized geologic model of a bedrock and overburden slope provided by the embodiment of the present invention; and

FIG. 10 is a flowchart of general steps for solving pore seepage by using a finite volume method provided by the embodiment of the present invention.

### PREFERRED EMBODIMENTS OF THE PRESENT INVENTION

The technical solutions in the embodiments of the present invention are described clearly and completely with reference to the drawings of the embodiments of the present invention below. Obviously, the described embodiments are merely part, not all, of the present invention. Any other embodiments achieved based on the embodiments of the present invention by those skilled in the art without any creative efforts shall fall within the protection scope of the present invention.

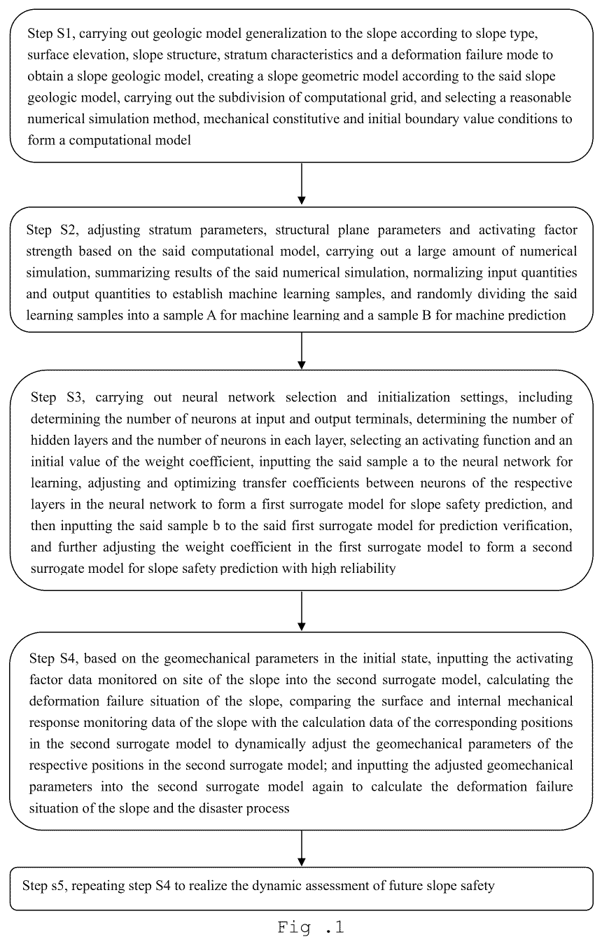

As shown in FIG. 1, the present invention provides a method for dynamically assessing slope safety, comprising the following steps.

Step S1, carrying out geologic model generalization to the slope according to slope type, surface elevation, stratum characteristics, slope structure and a deformation failure mode to obtain a slope geologic model, creating a slope geometric model according to the said slope geologic model, carrying out the subdivision of computational grid, and selecting a reasonable numerical simulation method, mechanical constitutive and initial boundary value conditions to form a computational model.

The slope type includes rocky slope, soil slope, and bedrock and overburden slope, the slope structure includes a bedding structure, an anti-dip structure, a blocky structure, a loose structure, and a soil-rock mixture structure, the deformation failure mode includes slipping landslide, toppling failure, and collapse failure.

The computational grid includes two-dimensional triangle, quadrilateral, polygon and disk grids, and three-dimensional tetrahedron, triangular prism, pyramid, hexahedron, polyhedron, and sphere grids.

The numerical simulation method includes a finite element method, a finite volume method, a finite difference method, a block discrete element method, a particle discrete element method, and a gridless method.

The mechanical constitutive includes Drucker-Prager constitutive, Mohr-Coulomb constitutive, Hoek-Brown constitutive, ubiquitous joint constitutive, and fracture energy constitutive.

According to the present invention, geologic model generalization to the slope is carried out according to the slope type, surface elevation, stratum characteristics, slope structure and a deformation failure mode, and the specific steps of constructing the geologic model of the slope are as follows:
Firstly, the key points of geologic model modeling are determined according to the slope type. For example, it needs to focus on the distribution and occurrence characteristics of the structural plane for a rocky slope, it needs to focus on soil stratification for a soil slope, and it needs to focus on the position and shape of a bedrock plane for a bedrock and overburden slope;
secondly, a geologic model containing three-dimensional information of the surface and stratum is constructed according to the surface elevation and stratum characteristic;
then, a geologic model containing geologic structure information is constructed according to the slope structure;
finally, a geologic model including the real or potential instability failure plane of the slope is constructed according to the deformation failure mode.

Further, according to the present invention, a slope geometric model is created according to the slope geologic model and subdivision of a computational grid is carried out. The specific steps are as follows:
Firstly, with the aid of special geometric modeling software (such as GOCAD, AutoCAD, GiD), a geometric model including terrain elements, stratum elements and structural plane elements is constructed by layer-by-layer modeling of points, lines, surfaces and bodies based on the surface elevation data, stratum data, slope structure data and failure mode data in the geologic model; and
then, different grid densities are set for different geometric regions, and the slope geometric model is subjected to grid subdivision by using two-dimensional triangles, quadrangles, three-dimensional tetrahedrons, triangular prisms, pyramids, hexahedrons and other grids to form a grid model.

According to the present invention, a slope computational model is constructed according to the geometric model obtained in the above steps, and the specific steps are as follows:

Each discrete grid in the geometric model is subjected to numerical calculation methods such as a finite element method and a finite volume method, and each discrete grid is given constitutive models and constitutive parameters such as Drucker-Prager constitutive and Mohr-Coulomb constitutive, and initial-boundary value conditions such as displacement, velocity, gravity and surface force are imposed on specific grids or nodes, and finally a complete computational model is formed.

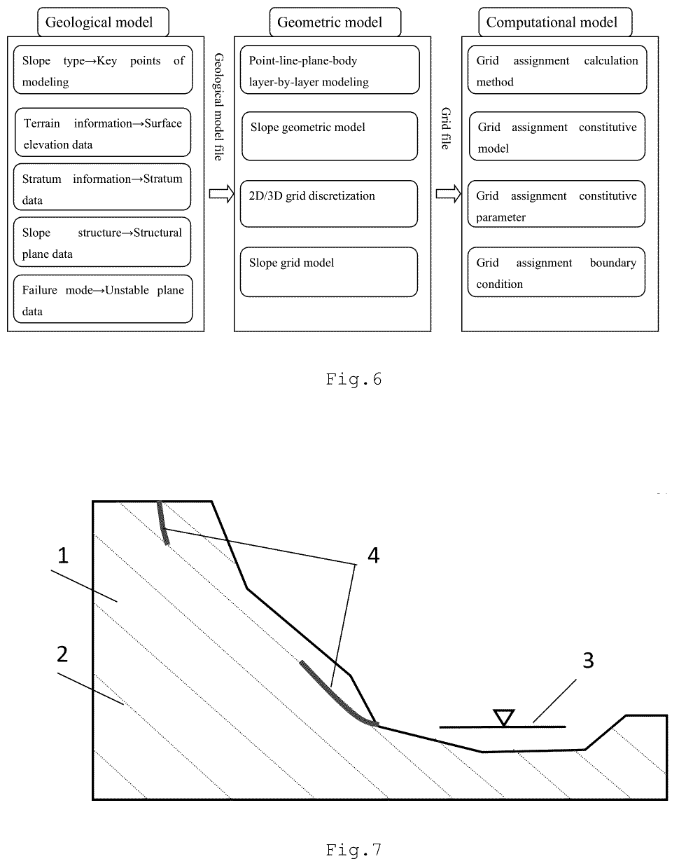

The steps of constructing the slope computational model in the present invention are shown in FIG. 6.

Step S2, adjusting stratum parameters, structural plane parameters and activating factor strength based on the said computational model, carrying out a large amount of numerical simulation, summarizing results of the numerical simulation, normalizing input quantities and output quantities to establish machine learning samples, and randomly dividing the learning samples into a sample A for machine learning and a sample B for machine prediction.

The stratum parameters mainly refer to the parameters suitable for the element constitutive, including density, elastic modulus, Poisson's ratio, cohesion, internal friction angle, tensile strength, dilatancy angle, etc.

Structural plane parameters include normal stiffness, tangential stiffness, cohesion, internal friction angle, tensile strength, etc.

The activating factor strength includes the strengths of rainfall, fluctuation of reservoir water or groundwater, earthquake, manual excavation and engineering blasting disturbance.

The numerical simulation method based on the computational model in step S1 includes the following specific steps:

Firstly, the lower limits and upper limits of each parameter in the stratum parameters, structural plane parameters and the activating factor strength are set, and different number of segments are set according to the influence degree of each parameter on the computation results of the computational model. For example, Poisson's ratio has little influence on the computation results of the computational model, and 2-3 levels can be set between the upper and lower limits (that is, 2-3 values are taken at equal intervals between the upper and lower limits) for the Poisson's ratio. Generally, cohesion has a great influence on the computation results of the computational model, and 5-6 levels of cohesion can be set between the upper and lower limits (that is, 5-6 values can be taken at equal intervals between the upper and lower limits) for cohesion.

After setting the levels between the upper limit and the lower limit are set for each parameter among formation parameters, structural plane parameters and activating factor strength, a computation sequence for each parameter can be formed, for example, the computation sequence for Poisson's ratio is {μs, μ1, μ2, μ3, μb}, and the computation sequence for cohesion is {Cs, C1, C2, C3, C4, C5, Cb}.

In the computation sequence of each parameter, the parameter values are adjusted by sequential computation or random sampling, and each parameter is substituted into the computational model after each adjustment to obtain the computation result of the computational model after each adjustment, thus realizing the numerical simulation computation of the computational model. For example, firstly, Poisson's ratio μ1 and cohesion C1 are selected by sampling, and the computation result result1 is simulated by substituting μ1 and C1 into the computational model. Sampling is carried out again to obtain Poisson's ratio μ2 and cohesion C4, and Poisson's ratio μ1 and cohesion C1 are adjusted to Poisson's ratio μ2 and cohesion C4. μ2 and C4 are substituted into the computational model to obtain a computational result result2 by simulation and computation. The numerical simulation computation of the computational model is realized in this way.

The parameter values after each parameter adjustment are combined with the computation results of the computational model after each adjustment to establish machine learning samples, for example {μ1, C1, result1}, {μ2, C4, result2} and other numerical simulation results are summarized as machine learning samples.

Step S3, carrying out neural network selection and initialization settings, including determining the number of neurons at input and output terminals, determining the number of hidden layers and the number of neurons in each layer, selecting an activating function and an initial value of the weight coefficient, inputting the sample A to the neural network for learning, adjusting and optimizing transfer coefficients between neurons of the respective layers in the neural network to form a first surrogate model for slope safety prediction, and then inputting the sample B to the first surrogate model for prediction verification, and further adjusting the weight coefficient in the first surrogate model to form a second surrogate model for slope safety prediction with high reliability.

The neural network comprises a forward neural network and a feedback neural network, the forward neural network comprises a single-layer perceptron, multi-layer perceptron, BP neural network, and the feedback neural network includes Hopfield, Hamming, BAM network.

Step S4, based on the geomechanical parameters in the initial state, inputting the activating factor data monitored on site of the slope into the second surrogate model, calculating the deformation failure situation of the slope, comparing the surface and internal mechanical response monitoring data of the slope with the calculation data of the corresponding positions in the second surrogate model to dynamically adjust the geomechanical parameters of the respective positions in the second surrogate model; and inputting the adjusted geomechanical parameters into the second surrogate model again to calculate the deformation failure situation of the slope and the disaster process.

The geomechanical parameters include density, elastic modulus, Poisson's ratio, cohesion, internal friction angle, tensile strength, dilatancy angle, tensile fracture energy, and shear fracture energy.

The activating factor includes rainfall, reservoir water or groundwater fluctuations, earthquakes, manual excavation, and engineering blasting disturbances.

The method for measuring the activating factor and the calculation process of the computational model for the activating factor are as follows:

Rainfall can be measured by a rain gauge, and input into the computational model by imposing a flow boundary on the upper surface of the slope (mountain surface). According to the flow boundary, the computational model realizes the transmission of rainfall to the inside of the slope through a seepage equation.

The fluctuation of reservoir water or groundwater is measured by a borehole water pressure sensor, and the parameters of rock and soil below the water level line are set as saturation parameters (the specific parameters include unit parameters such as density, elastic modulus, Poisson's ratio, cohesion, tensile strength, internal friction angle and dilatancy angle, and contact surface parameters such as normal contact stiffness, tangential contact stiffness, cohesion, internal friction angle and tensile strength). After change to saturation parameters, the mechanical behavior of rock and soil will change, so as to realize the effect of reservoir water or groundwater on rock and soil.

Seismic wave can be measured by burying a vibration acceleration sensor or a vibration velocity sensor in rock and soil, and the input of seismic wave can be realized by applying the measured vibration acceleration time history or vibration velocity time history to the bottom of the computational model. Under the control of a dynamic equation, the input seismic wave will be transmitted from the bottom of the model to the top gradually, and the slope will respond dynamically under the dual effects of self-weight stress and ground motion stress. If the strength is low, the slope will have instability failure.

The characterization of manual excavation area can be based on the design drawings provided by the designer, and can also be measured on the spot by means of a laser rangefinder. The manual excavation area needs to be considered separately when establishing the geometric model, and the manual excavation area can be marked by setting different physical groups. In the calculation process, the empty constitutive (excavation constitutive) is set for the elements in the manual excavation area. After setting the empty constitutive, the elements in the excavation area will disappear and the stress of these elements will be set to zero, thus realizing the simulation calculation of the manual excavation process.

The simulation of engineering blasting disturbance needs to measure the diameter, depth and position of specific blast holes, and can generally be modeled according to the blasting scheme. In the geometric modeling stage, the blastholes need to be established, and grid subdivision should be carried out and the explosion source model (for example a Landau explosion source model, a JWL explosion source model, etc. may be used) and initiation time should be set for each blasthole. After the numerical calculation starts, according to the set initiation time, the blast hole unit starts to be ignited and detonated according to the explosion source model, and the explosion stress will be transmitted to the surrounding rock and soil by the dynamic equation.

The inversion method of geomechanical parameters in slope current state includes a gradient descent method, a conjugate gradient method, and a Newton method.

Step S5, repeating step S4 to realize the dynamic assessment of future slope safety. The dynamic assessment of slope safety includes stability assessment and disaster risk assessment.

The present invention combines the on-site monitoring data, the numerical simulation analysis and the neural network prediction, creates geometric model and computational grid according to the slope type, provides samples for machine learning through a large number of numerical simulations, carries out deep learning with the help of the neural network to form the surrogate model for real-time prediction of the slope safety, carries out dynamic inversion on the geomechanical parameters in the surrogate model using the monitoring data to form accurate geomechanical input parameters of the current state, and inputs the adjusted geomechanical parameters into the surrogate model to dynamically assess the future slope safety. Compared with the conventional slope safety prediction model based only on the monitoring data, the present invention has higher prediction accuracy and is able to analyze and predict the range of the slope disaster. Compared with the conventional numerical simulation analysis, the present invention is able to dynamically adjust the geomechanical input parameters by using the monitoring data, making the prediction accuracy further higher, and can further achieve the real-time prediction due to the use of the surrogate model created by the neural network.

The present invention provides a first slope safety assessment example below.

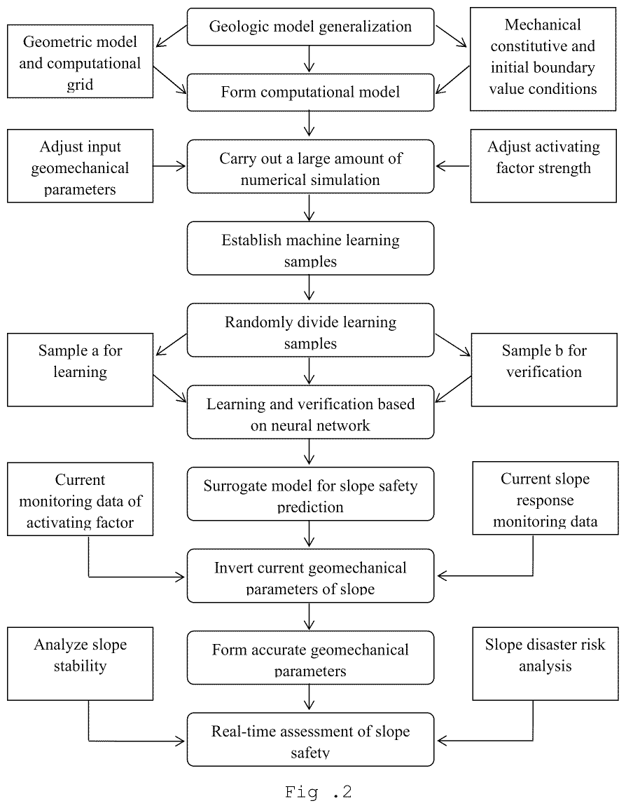

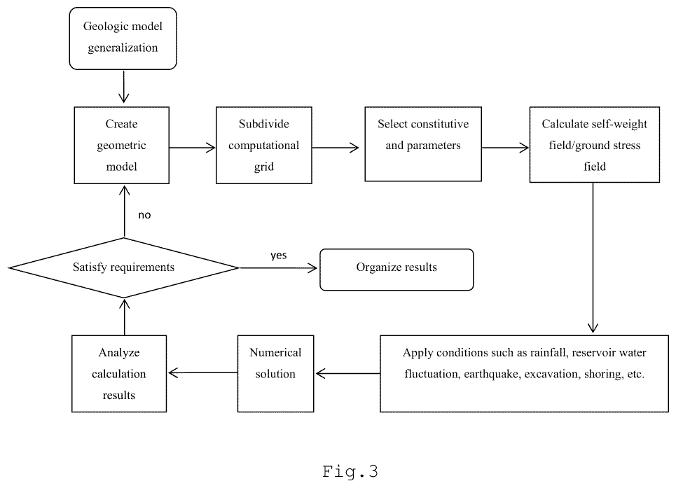

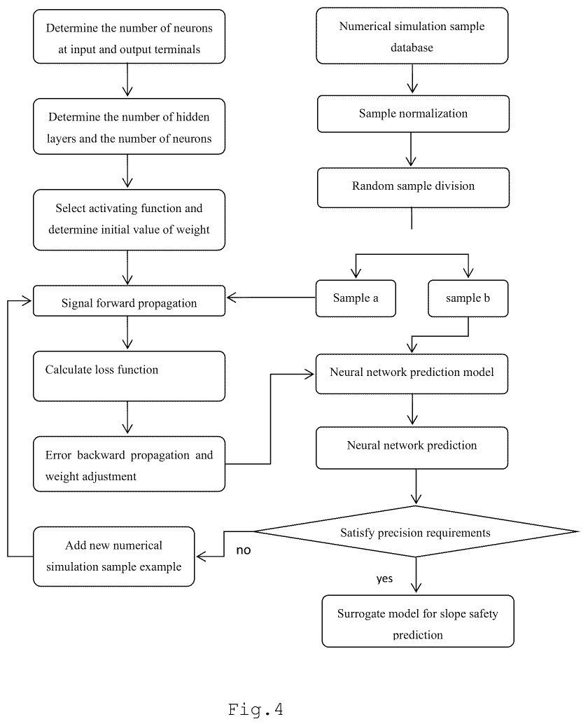

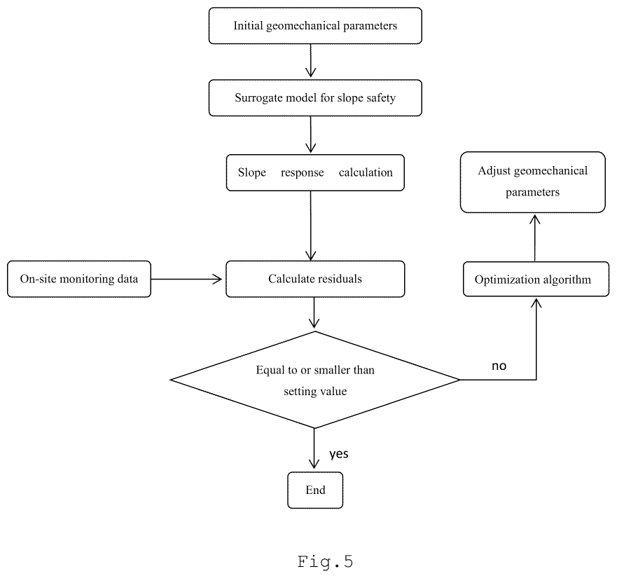

According to the flowcharts in FIG. 2-FIG. 6, the deformation failure situation of the certain slope, which has shown signs of deformation failure when the reservoir water level changes, is assessed in real time. This slope is a typical bedding rock slope with granite lithology. Bedding structural planes with an average spacing of 10 m are developed on the slope, with an inclination of 40°. There are compression-shear cracks at the foot of the slope and tension cracks at the top of the slope. According to the slope type, slope structure and signs of slope failure, a generalized geological model as shown in FIG. 7 is created. In FIG. 7, 1 indicates a rock stratum, 2 indicates the structural plane, and 3 indicates the current reservoir water level, and 4 indicates a deformation fracture surface. The model has a height of 120 m and a length of 200 m.

By using GID software, the geometric model is created and is subjected to grid subdivision, obtaining a total of 25632 triangular grids. A numerical simulation method is used to analyze the stability of the bedding rock slope. There are many numerical simulation methods, such as finite element method, finite volume method, finite difference method, block discrete element method, particle discrete element method and meshless method.

In this embodiment, the method of numerical simulation by the coupling finite element with discrete element is as follows:

The common-node triangular grids in the grid model are discretized and decomposed into two parts: grid and grid boundary. The calculation method of the rock mass is selected as a finite element method, and the calculation method of the structural plane is selected as a discrete element method. The elastic-plastic deformation characteristics of rock mass are characterized by the finite element, and the damage fracture and dislocation slip process of the structural plane are characterized by the discrete element. Normal displacement constraints are imposed on the grid nodes at the left and right sides and the bottom of the selected grid model, and the direction of gravity is vertically downward.

The rock mass adopts the linear elastic constitutive and the structural plane adopts the brittle Mohr-Coulomb constitutive. The initial parameters of the rock mass include the density of 2650 kg/m3, the elastic modulus of 35 GPa, the Poisson's ratio of 0.25. The parameters of the structural plane include the normal contact stiffness per unit area of 10 GPa/m, the tangential contact stiffness per unit area of 4 GPa/m, the cohesion of 0.9 MPa, the internal friction angle of 25.6°, the tensile strength of 0.5MPa. According to the failure characteristics of the bedding slope, the values of the cohesion, the internal friction angle and the tensile strength of the structural plane affect the deformation failure mode and the stability of the slope. While adjusting the cohesion of the structural plane to 2.0 MPa from 0.1 MPa, and the step pitch to 0.1 MPa, adjusting the tensile strength of the structural plane to 1.0 MPa from 0.1 MPa, and the step pitch to 0.1 MPa, adjusting the internal friction angle of the structural plane to 35° from 15°, and the step pitch to 1°, and adjusting the reservoir water level elevation to 2600 m from 2100 m, and the step pitch to 50 m, the numerical simulation calculation is carried out for 40,000 times to obtain the deformation failure situations of the slope under different structural plane strength parameters and different reservoir water levels.

The method for constructing the second surrogate model by using a BP neural network in the present invention is as follows:

By adopting the cohesion, the internal friction angle, the tensile strength and the rising value of the reservoir water level of the structural plane as input values, and the surface displacements at three typical positions on the slope surface as output values, the input parameters and output parameters are normalized to form samples for machine learning. The BP neural network is adopted for learning, the number of neurons in the input layer is 4, the number of neurons in the output layer is 3, the hidden layer is set to 3 layers, the number of neurons is 10 each time, and the sigmoid function is selected as the activating function. The 40,000 samples are randomly divided into 2 groups, including 35,000 samples as the group A for machine learning and 5,000 samples as the group B for verification. After the machine learning and the sample verification, a prediction surrogate mode for slope safety with the required accuracy is created to carry out deformation prediction of the rocky slope. A water pressure sensor or a water level elevation sensor is set in the reservoir to monitor the change of water level elevation in real time and the water level elevation data is input into the surrogate model, the displacement changes of the three monitoring points on the slope surface are calculated with the surrogate model the in real time and compared with the displacement of the corresponding position monitored by GNSS and surface displacement meter on the site, the two-norm of the difference between the calculated displacement and the actual displacement is used as the optimization target, and the conjugate gradient method is adopted for optimization. After 1200 iterations, the structural plane strength parameters of the bedding rock slope that best match the on-site monitoring data are found out. That is, the cohesion is 0.73 MPa, the internal friction angle is 28.2°, and the tensile strength is 0.24 MPa. By inputting the optimized and adjusted strength parameters and the change parameters of the future water level into the surrogate model, the real-time prediction of the impact of the water level change on the stability of the bedding rock slope is carried out.

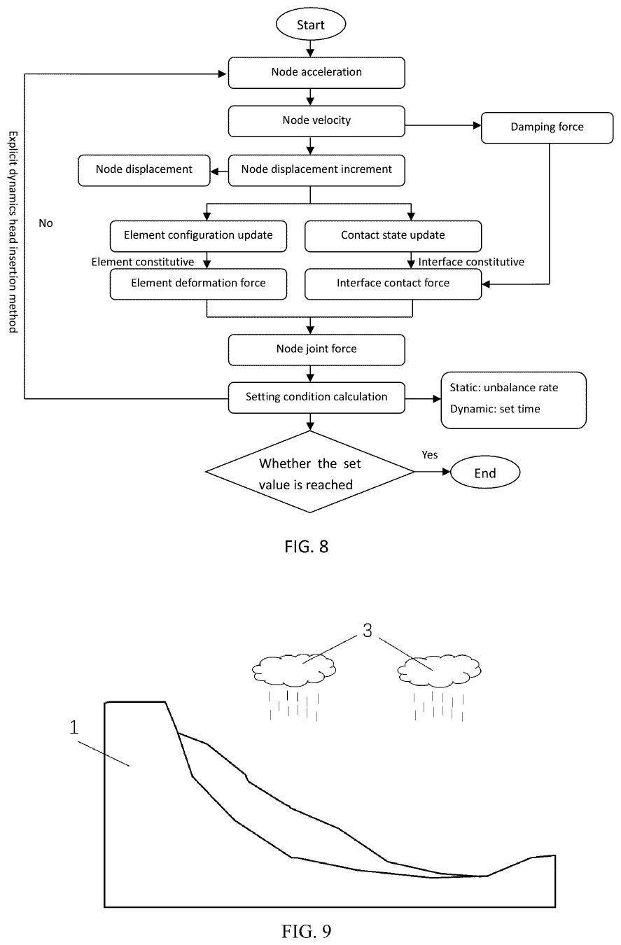

The specific calculation flow of slope stability analysis by using the coupling method of the finite element and discrete element is shown in FIG. 8:

A dynamic pre-differential method is used to calculate the node acceleration according to the node joint force, the node velocity according to the node acceleration, the node displacement increment and displacement according to the node velocity, the element strain increment according to the node displacement increment and update the element configuration and the contact relationship between elements, the element stress according to the cell strain increment, the total strain and the element constitutive model, the contact force at the contact point according to the contact surface displacement increment and the contact constitutive, the node joint force according to the element stress and the contact force at the contact point, and to judge whether to quit the calculation or not according to the convergence conditions of static or dynamic problems.

When the water level elevation data is applied to the computational model, it is essentially to adjust the material parameters below the water level elevation line, that is, the element parameters such as density, elastic modulus, Poisson's ratio, cohesion, tensile strength, internal friction angle, dilatancy angle, etc., and the contact surface parameters such as normal contact stiffness, tangential contact stiffness, cohesion, internal friction angle, tensile strength, etc., which are all parameters in saturated state, and are reduced on the basis of the aforementioned natural parameters in the form of reduction factors.

The present invention provides the second slope safety assessment example as follows.

The safety of a bedrock and overburden slope, which has undergone continuous deformation due to the rainfall, is assessed in real time according to the flowcharts in FIG. 2-FIG. 5. According to the slope type and rock layer characteristics, a geologic model is generalized, as shown in FIG. 9, where 1 indicates bedrock, 2 indicates overburden, and 3 indicates rainfall. By using GID software, the geometric model is created and is subjected to grid subdivision, obtaining a total of 12865 triangular elements. A numerical simulation method is used to analyze the rainfall stability of the foundation slope. There are many numerical simulation methods, such as finite element method, finite volume method, finite difference method, block discrete element method, particle discrete element method, meshless method, etc. In this embodiment, the numerical simulation is carried out based on the finite element method that can calculate the seepage-stress coupling effect and the water absorption weakening effect of the overburden. In the specific implementation, the normal displacement constraints are imposed on the element nodes on the left and right sides and the bottom of the model, and the direction of gravity is vertically downward.

The bedrock adopts the linear elastic constitutive and the overburden adopts the Mohr-Coulomb constitutive having water absorption softening effect. The geomechanical parameters of bedrock include the density of 2450 kg/m3, the elastic modulus of 15 GPa, the Poisson's ratio of 0.26. The geomechanical parameters of the overburden include the density of 2100 kg/m3, the elastic modulus of 1 GPa, the Poisson's ratio of 0.33, the cohesion of 50 kPa, the internal friction angle of 23°, the tensile strength of 20 kPa, the dilatancy angle of 15°, the porosity of 0.1, the permeability coefficient of 0.02 cm/s, the characteristic water absorption time of the overburden of 1 day, the modulus water absorption weakening coefficient of 0.8, and the strength water absorption weakening coefficient of 0.5. Since the basic geomechanical parameters of the overburden have been well understood in the previous investigation, five parameters including the rainfall intensity, the rainfall duration, the characteristic water absorption time of the overburden, the modulus water absorption weakening coefficient, and the strength water absorption weakening coefficient are selected as adjustment parameters, and each factor is adjusted to 5 levels, obtaining a total of 3125 examples for calculation. After the calculation of the examples is completed, the data of each group of examples is normalized and randomly divided into two groups, including 90% as a group A for machine learning and 10% as a group B for verification. The BP neural network is selected for learning, the number of neurons in the input layer is 5, the number of neurons in the output layer is 5, the hidden layer is set to 4 layers, the number of neurons is 8 each time, and the tanh function is selected as the activating function. After the machine learning and the sample verification, a prediction surrogate mode for slope safety with the required accuracy is created to carry out deformation prediction of the bedrock and overburden slope. A rain gauge is arranged on the site to monitor the change of rainfall in real time, and the rainfall is input into the surrogate model as the boundary condition of surface flow, and the initial material parameters are input into the surrogate model for calculation. The displacement values of the five monitoring points are give and compared with the actual values measured by GNSS and surface displacement meter on the site, the two-norm of the difference between the calculated displacement and the actual displacement is used as the optimization target, and the Newton iteration method is adopted for optimization. After 2630 iterations, the optimization parameters of the bedrock and overburden slope that best match the site monitoring data are found out. That is, the characteristic water absorption time of the overburden is 2.3 days, the modulus water absorption weakening coefficient is 0.89, and the strength water absorption weakening coefficient is 0.34. By inputting the optimized and adjusted parameters and possible future rainfall parameters into the surrogate model, the real-time prediction of the impact of rainfall on the stability and deformation failure of the bedrock and overburden slope is carried out.

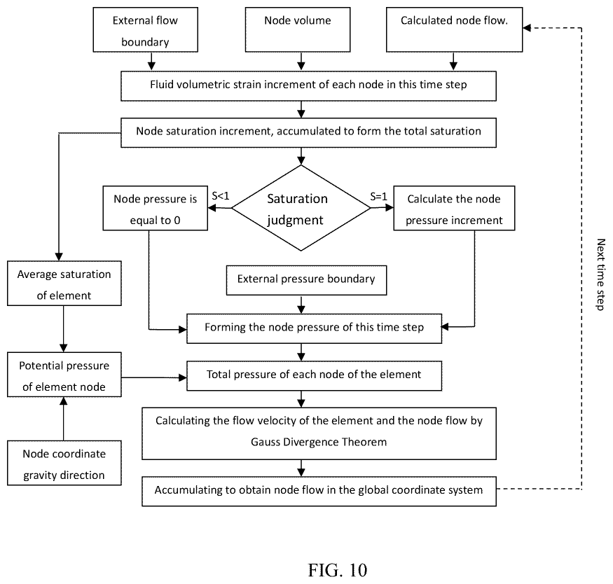

When the finite element method is used to simulate the rainfall seepage process and the solid deformation and failure process, the rainfall data will be applied to the upper surface of the slope grid model (mountain surface grid) in the form of flow boundary, and the finite volume method and Darcy's law are used for the solution fo the pore seepage process (the solution flow is shown in FIG. 10). The solution strategy of the solid deformation and failure part is the same as that of the finite element in the first example of the slope safety assessment. When solving the pore seepage at each time step, firstly, the fluid strain increment of each node at this time step is calculated according to the external flow boundary, node volume and node flow calculated in the previous step, then the node saturation increment is calculated and accumulated to form the total saturation; then the node pressure at this time step is calculated according to the saturation and external pressure boundary, the total pressure is calculated according to the node pressure of each element, and the flow velocity and node flow of the element are calculated according to the Gaussian divergence theorem, and accumulated in the global coordinate system to obtain the node flow.

In the fluid-solid coupling calculation, the influence of pore seepage on solids is realized by pore pressure and follows Biot consolidation theory. The influence of solids on pore seepage is realized by changing porosity and permeability coefficient. A mechanical model considering the water absorption weakening of solid strength parameters is introduced into the coupling algorithm. When the element reaches saturation state, the strength parameters of the element can be reduced according to the duration of saturation state, so as to simulate the process of slope saturation weakening.

The above embodiments are merely exemplary embodiments of the present application, which are not intended to limit the present application, and the protection scope of the present application is defined by the claims. Various modifications or equivalent substitutions that would be made by those skilled in the art without departing from the spirit and protection scope of the present application, shall fall within the protection scope of the present invention.

What is claimed is:

1. A method for dynamically assessing slope safety, comprising:
step S1, carrying out geologic model generalization to the slope according to slope type, surface elevation, stratum characteristics, slope structure and a deformation failure mode to obtain a slope geologic model, creating a slope geometric model according to the said slope geologic model, carrying out the subdivision of computational grid, and selecting a reasonable numerical simulation method, mechanical constitutive and initial boundary value conditions to form a computational model;
step S2, adjusting stratum parameters, structural plane parameters and activating factor strength based on the said computational model, carrying out a large amount of numerical simulation, summarizing results of the said numerical simulation, normalizing input quantities and output quantities to establish machine learning samples, and randomly dividing the said learning samples into a sample A for machine learning and a sample B for machine prediction;
step S3, carrying out neural network selection and initialization settings, including determining the number of neurons at input and output terminals, determining the number of hidden layers and the number of neurons in each layer, selecting an activating function and an initial value of weight coefficient, inputting the said sample A to a neural network for learning, adjusting and optimizing transfer coefficients between neurons of respective layers in the neural network to form a first surrogate model for slope safety prediction, and then inputting the said sample B to the said first surrogate model for prediction verification, and further adjusting the weight coefficient in the first surrogate model to form a second surrogate model for slope safety prediction with high reliability;
step S4, based on the geomechanical parameters in the initial state, inputting activating factor data monitored on site of the slope into the second surrogate model, calculating the deformation failure situation of the slope, comparing the surface and internal mechanical response monitoring data of the slope with the calculation data of the corresponding positions in the second surrogate model to dynamically adjust the geomechanical parameters of the respective positions in the second surrogate model; and inputting the adjusted geomechanical parameters into the second surrogate model again to calculate deformation failure situation of the slope and the disaster process; and
step S5, repeating step S4 to realize the dynamic assessment of future slope safety.

2. The method for dynamically assessing slope safety according to claim 1, wherein
the said slope type includes rocky slope, soil slope, and bedrock and overburden slope, the said slope structure includes a bedding structure, an anti-dip structure, a blocky structure, a loose structure, and a soil-rock mixture structure, and the said deformation failure mode includes slipping landslide, toppling failure, and collapse failure.

3. The method for dynamically assessing slope safety according to claim 1, wherein
the said computational grid includes two-dimensional triangle, quadrilateral, polygon and disk grids, and three-dimensional tetrahedron, triangular prism, pyramid, hexahedron, polyhedron, and sphere grids.

4. The method for dynamically assessing slope safety according to claim 1, wherein
the said numerical simulation method includes a finite element method, a finite volume method, a finite difference method, a block discrete element method, a particle discrete element method, and a gridless method.

5. The method for dynamically assessing slope safety according to claim 1, wherein
the said mechanical constitutive includes Drucker-Prager constitutive, Mohr-Coulomb constitutive, Hoek-Brown constitutive, ubiquitous joint constitutive, and fracture energy constitutive.

6. The method for dynamically assessing slope safety according to claim 1, wherein
the said geomechanical parameters include density, elastic modulus, Poisson's ratio, cohesion, internal friction angle, tensile strength, dilatancy angle, tensile fracture energy, and shear fracture energy.

7. The method for dynamically assessing slope safety according to claim 1, wherein
the said neural network comprises a forward neural network and a feedback neural network, the said forward neural network comprises a single-layer perceptron, multi-layer perceptron, BP neural network, and the said feedback neural network includes Hopfield, Hamming, BAM network.

8. The method for dynamically assessing slope safety according to claim 1, wherein
the said activating factor includes rainfall, reservoir water or groundwater fluctuations, earthquakes, manual excavation, and engineering blasting disturbances.

9. The method for dynamically assessing slope safety according to claim 1, wherein
the said dynamic assessment of slope safety includes stability assessment and disaster risk assessment.

10. The method for dynamically assessing the safety of a slope according to claim 1, wherein
the said inversion method of geomechanical parameters in slope current state includes a gradient descent method, a conjugate gradient method, and a Newton method.
